(19) United States
(12) Patent Application Publication
(10) Pub. No.: US 2004/0143492 A1
(43) Pub. Date: Jul. 22, 2004

(54) Process for restoring upgrade keys or promotional offers using a unique identifier

(76) Inventors: James A. Howell JR., Georgetown, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 10/346,159

(22) Filed: Jan. 17, 2003

(51) Int. Cl. G06F 17/60

(52) U.S. Cl. 705/14

(57) ABSTRACT

A method for restoring a purchase verification, which includes obtaining a service tag value that uniquely identifies an information handling system, obtaining a promotion code value that identifies a benefit, registering the benefit, the registering including linking the service tag value with the product code value, and during a software reinstall obtaining the promotion code value by providing the service tag value to a manufacturer.

### BACKGROUND OF THE INVENTION

1. Field of the Invention

This invention relates generally to purchase identification and verification, and, more particularly, to a process for restoring upgrade keys or promotional offers using unique identifiers.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A make-to-order computer manufacturer takes orders from a purchaser during an order transaction and accordingly assembles and configures a computer system conforming to the specifications requested by the purchaser. During the order transaction, the purchaser specifies the desired components of the computer system being ordered. At the time that the computer is assembled and configured at the factory, the computer manufacturer utilizes the information provided by the purchaser during the order transaction to assemble and configure the computer system according to the purchaser's specifications.

Make-to-order computer manufacturers have begun offering additional services, products, and other benefits along with the purchase of a computer. That is, at the time a purchaser specifies the desired components of the computer system during the order transaction, the purchaser can also specify additional services, products, or benefits that the purchaser wishes to purchase. For example, when the purchaser orders a computer system he can, at the same time, order and pay for pre-paid Internet Service Provider (“ISP”) services.

ISP services are related to communications that occur over the Internet. The Internet is a vast system of computers and computer networks that are interconnected through communication links. The interconnected computers exchange information, which may include information necessary to conduct purchases and other commercial activities over the Internet.

Each of the thousands of individual networks and organizations that make up the Internet is run and financed separately. A key component of these individual networks and organizations are the individual local networks that provides Internet access for individual users, known as Internet Service Providers (“ISP's”). An individual user that wishes to access the Internet pays the ISP a fee, such as a monthly connection rate. In return, the ISP acts as the intermediary between the user and the network “backbone” servers that provide access to the various networks within the Internet.

The practice of offering additional products, services, and benefits along with the purchase of a computer system raises several security, logistics, and customer experience concerns. One such concern arises from the fact that a purchaser of the manufacturer's computer systems may or may not order the pre-paid ISP service or other offered products and services. It is therefore necessary to devise a means by which the ISP or other provider of goods or services can determine, when the purchaser attempts to access the ISP or other provider, whether or not the purchaser has pre-paid for particular goods or services that the purchaser is requesting. Another concern is that the ISP or other provider must have a manner of identifying the purchaser. If the purchaser has pre-paid for a limited amount of monthly ISP access or a limited amount of other goods or services, the provider must identify the purchaser so that goods or services requested in an amount exceeding the prepaid amount may be tracked and charged to the proper person. Ideally, these concerns should be addressed in a way that minimizes implementation costs and requires as little action as possible from the purchaser.

One approach for addressing the above concerns is to issue a “product key” or password to the purchaser that encodes whether or not the purchaser has pre-paid for goods or services and, if so, identifies the good or services. The product key may be printed on a certificate that is delivered with the computer system. Alternatively, the product key may be generated by computer and e-mailed to the purchaser. When the purchaser has received the computer, he manually types the product key into the computer when attempting to gain access to the pre-purchased goods or services. This approach presents several disadvantages. First, with either the printed or computer-generated approach, the customer will be denied access unless he properly types the product key into the computer when it is requested. This feature could prevent, due to a typographical error, the purchaser from accessing goods or services for which he has already paid. With the printed product key approach, there is also the risk that the certificate bearing the printed product key will become destroyed, lost, or otherwise inaccessible to the purchaser.

One issue that arises when using a product key relates to when a client performs a software re-install or hard drive replacement on a computer system which includes a product key. In this situation, there is not a seamless way to restore the promotional offer or client upgrade keys to the computer system, or to even know what offers the user of the computer system was originally authorized to purchase. Often the client contacts the vendor via telephone to obtain the product keys and then manually re-enters the product keys onto the computer system.

### SUMMARY OF THE INVENTION

A software-generated purchase verification key (“product key”) is generated and stored on an information handling system at the factory where the make-to-order information handling system is assembled. During registration, a service tag is logged and linked to the upgrade key or promotional offer on the service or application provider's account management system. If a re-install of a base client occurs (either via a manual re-install or as a result of a hard drive replacement), the client connects to the registration server, the registration server reads the service tag, and registration server transparently provides the upgrade key back to the client thus enabling all features and capabilities associated with the product key. With a promotional offer, the offer is re-linked to the information handling system as well.

Such a process advantageously helps to reduce vendor customer service calls and improves the overall customer experience for system failures or hard drive restores. Such a process provides a an important piece of an overall services or application management processes.

In one embodiment, the invention relates to a method for restoring a purchase verification. The method includes obtaining a service tag value that uniquely identifies an information handling system, obtaining a promotion code value that identifies a benefit, registering the benefit, the registering including linking the service tag value with the product code value, and during a software reinstall obtaining the promotion code value by providing the service tag value to a manufacturer.

In another embodiment, the invention relates to a method for restoring a purchase verification. The method includes generating a promotion code, generating a service tag, storing the promotion code in the memory when the information handling system is assembled at a factory, configuring the information handling system to retrieve the promotion code from the memory when registering a benefit, authorizing a purchaser to receive the benefit if an acceptable promotion code is retrieved, and linking the service tag value with the promotion code value when the benefit is registered. The service tag uniquely identifies an information handling system. The information handling system includes a processor coupled to a memory.

In another embodiment, the invention relates to a system for restoring a purchase verification. The system includes means for obtaining a service tag value that uniquely identifies an information handling system, means for obtaining a promotion code value that identifies a benefit, means for registering the benefit, and means for obtaining the promotion code value by providing the service tag value to a manufacturer during a software reinstall. The registering includes linking the service tag value with the product code value.

In another embodiment, the invention relates to an apparatus for restoring a purchase verification. The system includes means for generating a promotion code, means for generating a service tag, means for storing the promotion code in the memory when the information handling system is assembled at a factory, means for configuring the information handling system to retrieve the promotion code from the memory when registering a benefit, means for authorizing a purchaser to receive the benefit if an acceptable promotion code is retrieved, and means for linking the service tag value with the promotion code value when the benefit is registered. The service tag uniquely identifies an information handling system. The information handling system includes a processor coupled to a memory.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of an information handling system.

FIG. 2 is a block diagram of an Internet connection.

FIG. 3 shows a flow chart of a product key based registration process.

FIG. 4 shows a flow chart of a promotion restore using a service tag.

The use of the same reference symbols in different drawings indicates identical items unless otherwise noted.

### DETAILED DESCRIPTION

It is to be understood that the present invention may be utilized to verify and authorize on-line access to any service, product, or benefit that has been pre-paid with the order of a computer system. These services, products and benefits may include, but are not limited to, ISP services. For simplicity, the discussion below presents the preferred embodiment, wherein the pre-paid service is ISP service. It will be understood, however, that many other types of pre-paid services, products, and benefits fall within the scope of the present invention, such as access to on-line or standalone software, on-site or on-line technical support or maintenance agreements, and on-line banking, stock trading, bill-paying or other financial services.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

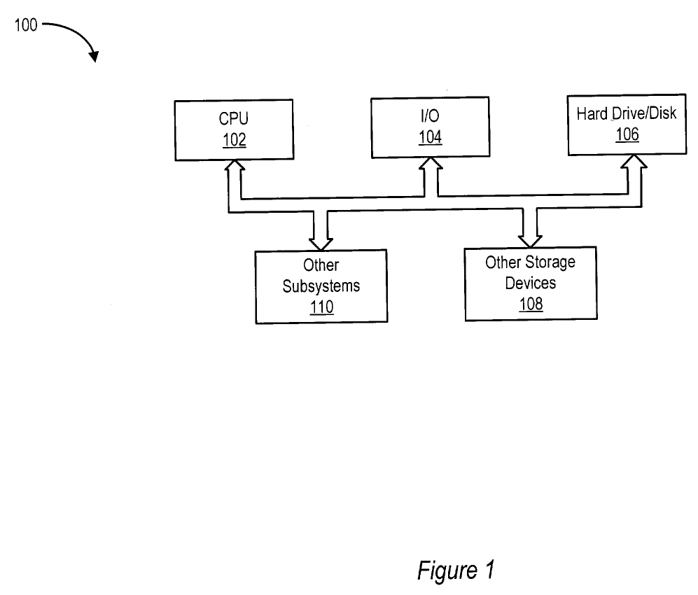

Referring to FIG. 1, a system block diagram of an information handling system 150 is shown having features thereof configured in accordance with the on-line store 110 as discussed. The information handling system 150 includes a processor 102, input/output (I/O) devices, such as a display, a keyboard, a mouse, and associated controllers, collectively designed by a reference numeral 104, a hard disk and drive 106, and other storage devices, such as a floppy disk and drive and other memory devices, collectively designated by a reference numeral 108, and various other subsystems, collectively designated by a reference numeral 110, all interconnected via one or more buses, shown collectively as a bus 112.

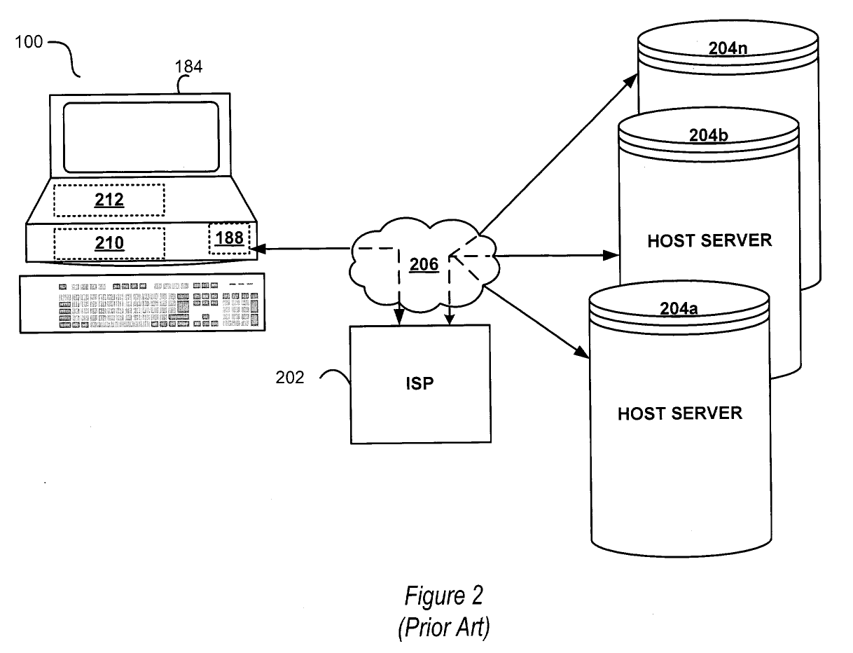

FIG. 2 illustrates that, when an individual user establishes a connection with the Internet 206 through the services of an ISP 202, the connection usually consists of four basic parts. First, the user interacts with a client computer 100, the client computer being a PC computer system or similar device. The client computer 100 includes a modem 188, communications software 210 and “browser” software 212. The modem 188 is the physical means by which the client computer 100 sends and receives communications to and from other computers and networks, including the Internet 206. The communications software 210 provides software support for those communications.

The second part of the connection is the ISP 202. The ISP 202 acts as a conduit for individuals to connect to the third part of the connection, the third part being the host computer, known as the “server” 204, at the other end of the connection. The ISP 202 receives a request for access from the client computer 100. Typically, the ISP 202 includes a collection of modems that accept multiple incoming requests simultaneously.

The ISP 202 processes the request and connects the user computer 100 to the Internet “backbone”, the backbone being very high-capacity lines that carry large amounts of Internet traffic. Several different data communication lines are available to connect a computer or computer system to the Internet. Common data communication lines include, but are not limited to, analog modems (14.4 Kbaud-56 Kbaud), ISDN (Integrated Services Digital Network), T1 lines, and Fractional T1 lines.

The third part of the Internet connection is the host server 204. The host runs special software that receives and reads requests sent from the browser 112. The browser 121 sends requests to a specific server computer 204a, 204b, 204n on the Internet to retrieve a specific document or Web page, once the Internet connection is established. Host servers 204 differ from typical client computers 100 in that host servers 204 can handle multiple telecommunications connections at one time. The host server 204 retrieves the appropriate information to be sent to the client computer 100. The server computer 204 is connected to the Internet backbone, and sends the appropriate information back to the client computer 100.

The fourth part of the Internet connection is the communications networks 206 that link together the first three components 100, 202, 204. FIG. 2 illustrates that the Internet connection is complete when the request from the client computer 100 results in a link being established with the host server 204.

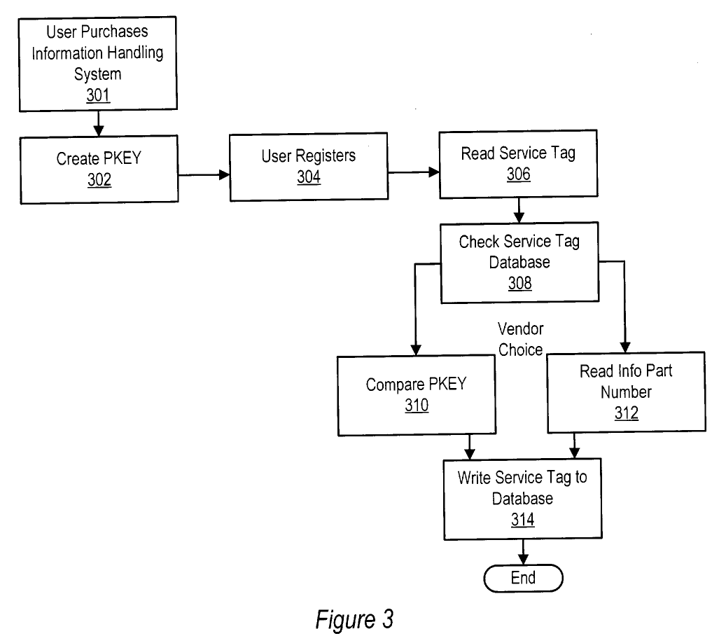

FIG. 3 shows a flow chart of a product key based registration process. More specifically, when a user purchases an information handling system at step 301, the manufacturing process begins. During the manufacturing process for the information handling system, a product key (PKEY) is loaded onto the information handling system 100 at step 302. The product key is created during a factory download process and includes information relating to services and/or software that were purchased along with the information handling system 100. When the user receives the information handling system 100, then the user starts a registration process for the services and/or software that were purchased along with the information handling system at step 304. During the registration process, the service tag is read from the information handling system 100 to verify that the information handling system corresponds to the manufacturer at step 306. The service tag may be read from the BIOS of the information handling system or from any other location in which the service tag is stored. The registration process then proceeds by checking a service tag database to assure that the information handling system 100 has not already registered for a particular promotion, service or software at step 308.

The registration process then proceeds down one of two paths depending on the preference of the service provider. In one operation, the registration process compares a product key to an information part number and if the comparison is successful, proceeds with the registration at step 310. In another operation the registration reads the info part number and proceeds with the operation at step 312. With either operation, the service tag is written to the service tag database to ensure that the same information handling system does not register more than once for the same promotion at step 314. The registration process then completes execution.

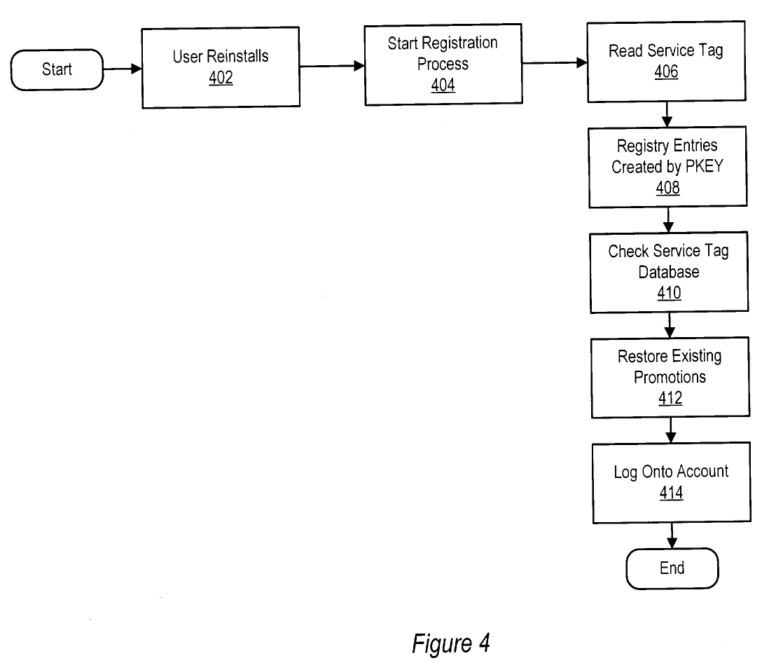

FIG. 4 shows a flow chart the operation of a promotion restore function using a service tag. More specifically, a user re-installs a service based application or installs a new hard drive image at step 402. This re-install may be, e.g., because of certain information handling system service issues. Next the user starts the registration process for the service or software at step 404. The registration process reads the service tag at step 406. The service tag may be read from BIOS or from registry entries created by a product key installation program. The registration process checks the service tag database for a preexisting registration associated with the service tag at step 410. This check of the database indicates whether the information handling system corresponding to the service tag has already registered for the particular service. Because the service tag is a unique identifier, the service provider may be assured that the user is not trying to install a particular service on more than one system. The registration process then restores the existing promotion onto the information handling system 100 and configures the information handling system 100 appropriately at step 412. The user may the log on with an account that is associated with the promotion as determined by the service tag at step 414.

### Other Embodiments

Other embodiments are within the following claims.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for restoring a purchase verification, comprising:
obtaining a service tag value that uniquely identifies an information handling system;
obtaining a promotion code value that identifies a benefit;
registering the benefit, the registering including linking the service tag value with the product code value; and,
during a software reinstall obtaining the promotion code value by providing the service tag value to a manufacturer.

2. The method of claim 1, further comprising;
installing application software in the memory when the information handling system is assembled at the factory.

3. The method of claim 1, wherein the benefit is an internet service.

4. The method of claim 1 further comprising
storing application software on the information handling system when the information system is assembled, the application software being a client signup application.

5. The method of claim 1 further comprising
restoring the benefit based upon the obtaining the promotion code value.

6. A method for restoring a purchase verification, comprising:
generating a promotion code
generating a service tag, the service tag uniquely identifying an information handling system, the information handling system including a processor coupled to a memory;
storing the promotion code in the memory when the information handling system is assembled at a factory; configuring the information handling system to retrieve the promotion code from the memory when registering a benefit;
authorizing a purchaser to receive the benefit if an acceptable promotion code is retrieved; and
linking the service tag value with the promotion code value when the benefit is registered.

7. The method of claim 6, further comprising;
installing application software in the memory when the information handling system is assembled at the factory.

8. The method of claim 6, wherein the benefit is an internet service.

9. The method of claim 6 further comprising
storing application software on the information handling system when the information system is assembled, the application software being a client signup application.

10. The method of claim 6 further comprising
restoring the benefit based upon the obtaining the promotion code value.

11. A system for restoring a purchase verification, comprising:
means for obtaining a service tag value that uniquely identifies an information handling system;
means for obtaining a promotion code value that identifies a benefit;
means for registering the benefit, the registering including linking the service tag value with the product code value; and,
means for obtaining the promotion code value by providing the service tag value to a manufacturer during a software reinstall.

12. The system of claim 11, further comprising;
means for installing application software in the memory when the information handling system is assembled at the factory.

13. The system of claim 11, wherein the benefit is an internet service.

14. The system of claim 11 further comprising
means for storing application software on the information handling system when the information system is assembled, the application software being a client signup application.

15. The system of claim 11 further comprising
means for restoring the benefit based upon the obtaining the promotion code value.

16. An apparatus for restoring a purchase verification, comprising:
means for generating a promotion code
means for generating a service tag, the service tag uniquely identifying an information handling system, the information handling system including a processor coupled to a memory;
means for storing the promotion code in the memory when the information handling system is assembled at a factory;
means for configuring the information handling system to retrieve the promotion code from the memory when registering a benefit;
means for authorizing a purchaser to receive the benefit if an acceptable promotion code is retrieved; and
means for linking the service tag value with the promotion code value when the benefit is registered.

17. The apparatus of claim 16, further comprising;
means for installing application software in the memory when the information handling system is assembled at the factory.

18. The apparatus of claim 16, wherein the benefit is an internet service.

19. The apparatus of claim 16 further comprising
means for storing application software on the information handling system when the information system is assembled, the application software being a client signup application.

20. The apparatus of claim 16 further comprising
means for restoring the benefit based upon the obtaining the promotion code value.
